(19) United States
(12) Patent Application Publication
(10) Pub. No.: US 2015/0322294 A1
(43) Pub. Date: Nov. 12, 2015

(54) POLISHING COMPOSITION

(71) Applicant: FUJIMI INCORPORATED, Kiyosu-shi, Aichi (JP)

(72) Inventor: Shogo ONISHI, Kiyosu-shi, Aichi (JP)

(21) Appl. No.: 14/655,597

(22) PCT Filed: Oct. 25, 2013
(86) PCT No.: PCT/JP2013/078968

§ 371 Date: Jun. 25, 2015

(30) Foreign Application Priority Data
Dec. 28, 2012 (JP) 2012-288415

(51) Int. Cl. C09G 1/02; B24B 37/04; C09K 3/14

(52) U.S. Cl. CPC C09G 1/02; C09K 3/1436; B24B 37/044

(57) ABSTRACT

Provided is a polishing composition which can suppress scratches on the surface of a metal substrate as an object to be polished, while suppressing dishing of the metal substrate. Disclosed is a polishing composition including functional polishing particles and water, the functional polishing particles containing a surface-modifying group having, at one end, a functional group that suppresses dissolution of a metal substrate by adsorbing to the metal substrate, and metal oxide particles to which the surface-modifying group is immobilized.

### TECHNICAL FIELD

The present invention relates to a polishing composition.

### BACKGROUND ART

In recent years, new microfabrication technologies have been developed along with high integration of LSI and an enhancement of performance. One of them is a chemomechanical polishing (hereinafter, also simply described as CMP) method, and this is a technology that is frequency used in the LSI production processes, particularly flattening of an interlayer insulating film, formation of a metal plug, and formation of an embedded wiring (damascene wiring) in multilayer interconnection forming processes.

In the case of forming a wiring in a semiconductor device, generally, first, a barrier layer and a conductive material layer are sequentially formed on an insulating film having trenches. Thereafter, at least the portion of the conductive material layer located outside the trenches (outer part of the conductive material layer) and the portion of the barrier layer located outside the trenches (outer part of the barrier layer) are removed by chemomechanical polishing (CMP). This polishing intended for removing at least the outer part of the conductive material layer and the outer part of the barrier layer is usually carried out separately in a first polishing step and a second polishing step. In the first polishing step, a portion of the outer part of the conductive material layer is removed in order to expose the upper surface of the barrier layer. In the subsequent second polishing step, at least the remaining portion of the outer part of the conductive material layer and the outer part of the barrier layer are removed in order to obtain a flat surface while exposing the insulating film.

In CMP for forming such a wiring in a semiconductor device, a polishing composition containing a polishing accelerator such as an acid and an oxidizing agent, and also optionally containing polishing particles is generally used. Furthermore, it has also been suggested to use a polishing composition which further contains a metal anticorrosive agent, in order to improve flatness of the object to be polished after polishing, that is, in order to suppress dishing by which the wiring section is over-polished. For example, JP-H08-83780 A discloses a polishing composition containing aminoacetic acid and/or amidosulfuric acid, an oxidizing agent, benzotriazole, and water.

### SUMMARY OF INVENTION

In a case in which a wiring of a semiconductor device, particularly a semiconductor having a conductive material layer formed from copper or a copper alloy, is formed by CMP, dishing by which the wiring section is over-polished, or scratching becomes a problem. Furthermore, as more advanced technologies are applied to the device, the demanded value of dishing or the demanded number of scratches is decreased. Even if the polishing composition disclosed in JP-H08-83780 A is used, it has been difficult to achieve the demanded performance of such advanced devices.

Thus, it is an object of the present invention to provide a polishing composition which can suppress scratches on the surface of a metal substrate, which is an object to be polished, while suppressing dishing of the metal substrate.

In order to solve the object described above, the inventors of the present invention conducted thorough investigations. As a result, the inventors found that the object described above can be solved by a polishing composition which includes novel polishing particles containing a surface-modifying group having, at one end, a functional group that suppresses dissolution of a metal substrate by adsorbing to the metal substrate, and metal oxide particles to which the surface-modifying group is immobilized. Thus, the inventors completed the present invention based on the above-described findings.

That is, the present invention provides a polishing composition which includes water and functional polishing particles containing a surface-modifying group having, at one end, a functional group that suppresses dissolution of a metal substrate by adsorbing to the metal substrate, and metal oxide particles to which the surface-modifying group is immobilized.

### DESCRIPTION OF EMBODIMENTS

The present invention is a polishing composition including functional polishing particles and water, the functional polishing particles containing a surface-modifying group having, at one end, a functional group capable suppressing dissolution of a metal substrate by adsorbing to the metal substrate, and metal oxide particles to which the surface-modifying group is immobilized.

When such a configuration is adopted, a polishing composition capable of suppressing scratches on the surface of a metal substrate, which is an object to be polished, while suppressing dishing of the metal substrate, is obtained.

The specific reason why such an effect as described above can be obtained by using the polishing composition of the present invention is not clearly understood; however, it is speculated that when the functional polishing particles described above are used, the functional group in the surface-modifying group adsorbs to the metal substrate and suppresses dissolution of metal from the metal substrate, and it is believed that as a result, dishing of the metal substrate can be suppressed. Furthermore, in regard to scratches, it is speculated that when the metal oxide particles are surface-modified, dispersibility of the functional polishing particles is enhanced, and an effect of suppressing the scratches on the metal substrate surface occurring due to aggregated polishing particles may be obtained. Meanwhile, the above-described mechanism is based on supposition, and the present invention is not intended to be limited by the mechanism by any means.

Hereinafter, the configuration of the polishing composition of the present invention is explained in detail.

[Metal Substrate]

The metal substrate that serves as an object to be polished of the present invention preferably has a conductive material layer, and optionally has a barrier layer and an insulating film.

The material included in the conductive material layer is not particularly limited, and examples thereof include metals such as copper, aluminum, hafnium, cobalt, nickel, titanium, and tungsten. The aforementioned metals may be included in the conductive material layer in the form of an alloy or a metal compound. Preferred examples include copper and copper alloys. These materials may be used singly, or in combination of two or more kinds.

The material included in the barrier layer is not particularly limited, and examples thereof include noble metals such as tantalum, titanium, tungsten, cobalt, gold, silver, platinum, palladium, rhodium, ruthenium, iridium, and osmium. These metals may be included in the barrier layer in the form of an alloy or a metal compound. These metals may be used singly or in combination of two or more kinds.

Examples of the material included in the insulating film include materials containing Si, such as TEOS (tetraethoxysilane).

[Functional Polishing Particles]

The functional polishing particles included in the polishing composition of the present invention have an action of mechanically polishing a metal substrate, and also suppress dishing of the metal substrate.

Furthermore, since the functional polishing particles are in the form of metal oxide particles being surface-modified, the functional polishing particles have favorable dispersibility. Therefore, the polishing particles also have an effect of suppressing scratches on the metal substrate surface occurring due to aggregated polishing particles.

The functional polishing particles contain a surface-modifying group having, at one end, a functional group that suppresses dissolution of a metal substrate by adsorbing to the metal substrate, and metal oxide particles to which the surface-modifying group is immobilized. The form of immobilization is not particularly limited, but a form in which the surface-modifying group is chemically bonded to the metal oxide particles is preferred.

[Metal Oxide Particles]

Specific examples of the metal oxide particles include, for example, particles of silica, alumina, ceria, and titania. The metal oxide particles may be used singly or as mixtures of two or more kinds. Also, regarding the polishing particles, a commercially available product may be used, or a synthesized product may be used.

Among these metal oxides, silica is preferred, and particularly preferred is colloidal silica.

[Surface-Modifying Group]

The surface-modifying group related to the present invention has a functional group that suppresses dissolution of a metal substrate by adsorbing to the metal substrate (hereinafter, also simply referred to as functional group), at one end. Furthermore, it is preferable that the surface-modifying group has a divalent linking group that connects between the functional group and the metal oxide particles (hereinafter, also simply referred to as linking group).

Examples of the functional group include an acyl group, an acetyl group, an aldehyde group, an epoxy group, a carboxyl group, a sulfo group, a mercapto group, a nitro group, a phosphoric acid group, an amide group, an amino group, a cyano group, a carbonyl group, an imino group, an azo group, an azide group, a phenyl group, a pyrrolyl group, a pyrazolyl group, an imidazolyl group, a dihydroimidazolyl group, a triazolyl group, a benzotriazolyl group, a tetrazolyl group, a pyridinyl group, a pyrazinyl group, a pyridazinyl group, a pyrimidinyl group, an indolizinyl group, an indolyl group, an isoindolyl group, an indazolyl group, a purinyl group, a quinolidinyl group, a quinolinyl group, an isoquinolinyl group, a naphthyridinyl group, a phthalazinyl group, a quinoxalinyl group, a quinazolinyl group, a cinnolinyl group, a pteridinyl group, a thiazolyl group, an isothiazolyl group, an oxazolyl group, an isoxazolyl group, and a furazanyl group. The functional polishing particles related to the present invention may have one kind of these functional groups, or may have plural kinds thereof. Furthermore, each of these functional groups may have a substituent, or may have no substituent. Examples of the substituent include an alkyl group, a cycloalkyl group, an aralkyl group, an alkoxy group, an aryl group, an aryloxy group, a halogen atom (Cl, Br or F), an alkoxycarbonyl group, an alkylthio group, an arylthio group, an amino group, a substituted amino group, an amide group, a sulfonamide group, a ureido group, a substituted ureido group, a carbamoyl group, a substituted carbamoyl group, a sulfamoyl group, a substituted sulfamoyl group, an alkylsulfonyl group, an arylsulfonyl group, a hydroxyl group, a cyano group, a nitro group, a sulfo group, and a carboxyl group.

Among these functional groups, preferred from the viewpoint of suppressing dishing is at least one kind selected from the group consisting of a mercapto group, a cyano group, a phenyl group, a dihydroimidazolyl group, a benzotriazolyl group, and a tetrazolyl group.

Suitable examples of the linking group include a divalent hydrocarbon group which may have a substituent, a divalent linking group containing a heteroatom, and an alkylenesiloxy group. When it is said that the hydrocarbon group “has a substituent”, it is implied that some or all of the hydrogen atoms in the hydrocarbon group are substituted with groups or atoms other than hydrogen atom. The hydrocarbon group is preferably an aliphatic hydrocarbon group. The aliphatic hydrocarbon group means a hydrocarbon group which is not aromatic. The aliphatic hydrocarbon group may be saturated or unsaturated, and it is usually preferable that the aliphatic hydrocarbon group be saturated.

In regard to the divalent hydrocarbon group, more specific examples of the aliphatic hydrocarbon group include a linear or branched aliphatic hydrocarbon group, and an aliphatic hydrocarbon group containing a ring in the structure.

The linear or branched aliphatic hydrocarbon group preferably has 1 to 10 carbon atoms, more preferably 1 to 8 carbon atoms, and even more preferably 1 to 5 carbon atoms.

The linear aliphatic hydrocarbon group is preferably a linear alkylene group, and specific examples thereof include a methylene group (—CH₂—), an ethylene group (—(CH₂)₂—), a trimethylene group (propylene group) (—(CH₂)₃—), a tetramethylene group (butylene group) (—(CH₂)₄—), and a pentamethylene group (pentylene group) (—(CH₂)₅—).

The branched aliphatic hydrocarbon group is preferably a branched alkylene group, and specific examples thereof include alkylalkylene groups including alkylmethylene groups such as —CH(CH₃)—, —CH(CH₂CH)—, —C(CH₃)₂—, —C(CH₃) (CH₂CH₃)—, —C(CH₃)(CH₂CH₂CH₃)—, and —C(CH₂CH₃)₂—; alkylethylene groups such as —CH(CH₃)CH₂—, —CH(CH₃)CH(CH₃)—, —C(CH₃)₂CH₂—, —CH(CH₂CH₃)CH₂—, and —C(CH₂CH₃)₂—CH₂—; alkyltrimethylene groups such as —CH(CH₃)CH₂CH₂— and —CH₂CH(CH₃)CH₂—; and alkyltetramethylene groups such as —CH(CH₃)CH₂CH₂CH₂— and —CH₂CH(CH₃)CH₂CH₂—. The alkyl group in an alkylalkylene group is preferably a linear alkyl group having 1 to 5 carbon atoms.

The linear aliphatic hydrocarbon group may have a substituent, or may have no substituent. Examples of the substituent include an oxygen atom (═O).

Examples of the aliphatic hydrocarbon group containing a ring in the structure include a cyclic aliphatic hydrocarbon group (a group obtained by eliminating two hydrogen atoms from an aliphatic hydrocarbon ring), and a group in which the cyclic aliphatic hydrocarbon group is bonded to an end of the aforementioned linear aliphatic hydrocarbon group, or the linear aliphatic hydrocarbon group is interrupted by the cyclic aliphatic hydrocarbon group.

The cyclic aliphatic hydrocarbon group preferably has 3 to 20 carbon atoms, and more preferably 3 to 12 carbon atoms.

The cyclic aliphatic hydrocarbon group may be a polycyclic group, or may be a monocyclic group. The monocyclic group is preferably a group obtained by eliminating two hydrogen atoms from a monocycloalkane having 3 to 6 carbon atoms, and examples of the monocycloalkane include cyclopentane and cyclohexane. The polycyclic group is preferably a group obtained by eliminating two hydrogen atoms from a polycycloalkane having 7 to 12 carbon atoms, and specific examples of the polycycloalkane include adamantane, norbornane, isobornane, tricyclodecane, and tetracyclododecane.

The cyclic aliphatic hydrocarbon group may have a substituent, or may have no substituent. Examples of the substituent include an alkyl group having 1 to 5 carbon atoms, and an oxygen atom (═O).

When the linking group is a divalent linking group containing a heteroatom, examples of the divalent linking group containing a heteroatom include —O—, —C(═O)—O—, —C(═O)—, —O—C(═O)—O—, —C(═O)—NH—, —NH— (wherein H may be substituted by a substituent such as an alkyl group or an acyl group), —S—, —S(═O)₂—, —S(═O)₂—O—, “-A-O (oxygen atom) —B— (provided that A and B each independently represent a divalent hydrocarbon group which may have a substituent)”, and a combination of a divalent hydrocarbon group which may have a substituent and a divalent linking group containing a heteroatom. Examples of the divalent hydrocarbon group which may have a substituent include groups similar to the above-described hydrocarbon group which may have a substituent, and an aliphatic hydrocarbon group which is linear or branched or contains a ring in the structure, is preferred.

Examples of the case in which the linking group is an alkylenesiloxy group include, for example, an ethylenedimethoxysiloxy group (—(CH₂)₂—Si(OCH₃)₂—O—), a propylenedimethoxysiloxy group (—(CH₂)₃—Si(OCH₃)₂—O—), a butylenedimethoxysiloxy group (—(CH₂)₄—Si(OCH₃)₂—O—), an ethylenediethoxysiloxy group (—(CH₂)₂—Si(OC₂H₅)₂—O—), a propylenediethoxysiloxy group (—(CH₂)₃—Si(OC₂H₅)₂—O—), and a butylenediethoxysiloxy group (—(CH₂)₄—Si(OC₂H₅)₂—O—).

Among these linking groups, an ethylenedimethoxysiloxy group (—(CH₂)₂—Si(OCH₃)₂—O—), a propylenedimethoxysiloxy group (—(CH₂)₃—Si(OCH₃)₂—O—), or a butylenedimethoxysiloxy group (—(CH₂)₄—Si(OCH₃)—O—) is preferred.

A more preferred surface-modifying group may be a surface-modifying group having a propylenedimethoxysiloxy group as a linking group.

[Method for Producing Functional Polishing Particles]

The method for producing functional polishing particles related to the present invention is not particularly limited; however, for example, the functional polishing particles can be produced by adding a silane coupling agent to the metal oxide particles described above, and allowing the agent to react with the metal oxide particles to form bonding.

Examples of the silane coupling agent used include, for example, aromatic silanes such as phenyltrimethoxysilane and phenyltriethoxysilane; epoxy-based silanes such as 3-glycidoxypropyltrimethoxysilane, 3-glycidoxypropylmethyldiethoxysilane, 3-glycidoxypropyltriethoxysilane, and 2-(3,4-epoxycyclohexyl)ethyltrimethoxysilane; aminosilanes such as 3-aminopropyltriethoxysilane, 3-aminopropyltrimethoxysilane, 3-aminopropyldimethylethoxysilane, 3-aminopropylmethyldiethoxysilane, 4-aminobutyltriethoxysilane, 3-aminopropyldiisopropylethoxysilane, 1-amino-2-(dimethylethoxysilyl)propane, (aminoethylamino)-3-isobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, N-(6-aminohexyl)aminomethyltrimethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, 11-aminoundecyltriethoxysilane, 3-(m-aminophenoxy)propyltrimethoxysilane, m-aminophenyltrimethoxysilane, p-aminophenyltrimethoxysilane, (3-trimethoxysilylpropyl)diethylenetriamine, N-methylaminopropylmethyldimethoxysilane, N-methylaminopropyltrimethoxysilane, dimethylaminomethylethoxysilane, (N,N-dimethylaminopropyl)trimethoxysilane, and (N-acetylglycidyl)-3-aminopropyltrimethoxysilane; mercapto-based silanes such as 3-mercaptopropylmethyldimethoxysilane, 3-mercaptopropyltrimethoxysilane, and 3-mercaptopropyltriethoxysilane; organoalkoxysilanes having nitrogen-containing heterocyclic rings, such as N-(3-triethoxysilylpropyl)-4,5-dihydroimidazole, N-[3-(triethoxysilylpropyl)]benzotriazole, 2-(trimethoxysilylethyl)pyridine, N-(3-trimethoxysilylpropyl)pyrrole, and N-[3-(triethoxysilyl)propyl]-2-carbomethoxyaziridine; organoalkoxysilanes having a nitro group, such as 3-(2,4-dinitrophenylamino)propyltriethoxysilane and 3-(triethoxysilylpropyl)-p-nitrobenzamide; organoalkoxysilanes having a carboalkoxy group, such as 2-(carbomethoxy)ethyltrimethoxysilane; organoalkoxysilanes having an aldehyde group, such as triethoxysilylbutylaldehyde; organoalkoxysilanes having a ketone group, such as 2-hydroxy-4-(3-methyldiethoxysilylpropoxyl)diphenyl ketone; and organoalkoxysilanes having a cyano group, such as 2-cyanoethyltriethoxysilane, 3-cyanopropylphenyldimethoxysilane, 11-cyanodecyltrimethoxysilane, 3-cyanopropyltrimethoxysilane, and 3-cyanopropyltriethoxysilane.

These silane coupling agents may be used singly or in combination of two or more kinds thereof.

Among these silane coupling agents, phenyltrimethoxysilane, 3-aminopropyltrimethoxysilane, 3-mercaptopropyltrimethoxysilane, N-(3-triethoxysilylpropyl)-4,5-dihydroimidazole, N-[3-(triethoxysilylpropyl)]benzotriazole, and 3-cyanopropyltrimethoxysilane are preferred.

Regarding the silane coupling agent, a commercially available product may be used, or a synthesized product may be used. The method for synthesizing a silane coupling agent is not particularly limited, and for example, a known method of causing a halogen-containing silane compound such as 3-bromopropyltrimethoxysilane to react with the aforementioned compound having a functional group in a solvent such as toluene or xylene in the presence of an acid catalyst such as sulfuric acid, may be used.

The solvent used in the synthesis reaction between metal oxide particles and a silane coupling agent is not particularly limited, and examples thereof include water; and other organic solvents including lower alcohols such as methanol, ethanol, n-propanol, and isopropyl alcohol; ketones such as acetone and methyl ethyl ketone; ethers such as diethyl ether, dioxane, and tetrahydrofuran; amides such as N,N-dimethylformamide; and sulfoxides such as dimethyl sulfoxide. Among these, preferred examples are organic solvents. These solvents may be used singly or in mixture of two or more kinds.

For example, in the case of adding a silane coupling agent to a water-dispersed colloidal silica, it is preferable to add a hydrophilic solvent thereto to the extent that the silane coupling can be dissolved. Examples of the hydrophilic organic solvent include alcohols such as methanol, ethanol, and isopropyl alcohol. Among these, it is preferable to use an alcohol of the same kind as that of the alcohol produced by hydrolysis of the silane coupling agent used. This is because when an alcohol of the same kind as that of the alcohol produced by hydrolysis of the silane coupling agent is used, recovery and reutilization of the solvent can be carried out more easily.

The lower limit of the amount of use of the silane coupling agent at the time of the synthesis reaction is preferably 0.1 mol % or more, more preferably 1 mol % or more, and even more preferably 10 mol % or more, when the number of moles of the metal oxide particles is taken as 100 mol %. The upper limit of the amount of use of the silane coupling agent at the time of the synthesis reaction is preferably 90 mol % or less, more preferably 85 mol % or less, and even more preferably 80 mol % or less, when the number of moles of the metal oxide particles is taken as 100 mol %. When the amount of use is in this range, the zeta potential in acidity is sufficiently stabilized, and gelling of the metal oxide particles over time can be prevented.

Meanwhile, in the case of using colloidal metal oxide particles such as colloidal silica, the amount of use of the silane coupling agent can be determined according to the following Mathematical Formula 1, from the specific surface area of the metal oxide particles measured by the BET method.

Number of moles of silane coupling agent required by 1 g of metal oxide particles=BET specific surface area of metal oxide particles/(occupied area of one molecule of silane coupling agent)/(6.02×10²³ (molecules/mol) [Mathematical Formula 1]

The atmosphere at the time of the synthesis reaction is not particularly limited, and the reaction can be carried out in an air atmosphere; an inert gas atmosphere of nitrogen, argon or the like; or in a vacuum.

The pH at the time of the synthesis reaction is also not particularly limited, but the pH is preferably from 7 to 11. When the pH is in this range, the silane coupling agent efficiently reacts with the metal oxide particles, and the risk of the silane coupling agent molecules undergoing self-condensation can be reduced.

The lower limit of the reaction temperature is not particularly limited, but the lower limit is preferably 5° C. or higher, more preferably 7° C. or higher, and even more preferably 10° C. or higher. Furthermore, the upper limit of the reaction temperature is not particularly limited, but the upper limit is preferably 100° C. or lower, more preferably 95° C. or lower, and even more preferably 90° C. or lower.

The lower limit of the reaction time is not particularly limited, but the lower limit is preferably 1 hour or longer, more preferably 2 hours or longer, and even more preferably 3 hours or longer.

Meanwhile, the synthesis reaction may be carried out in a single stage, or may be carried out in two stages by changing the temperature.

After completion of the reaction, the intended surface-modified metal oxide particles can be obtained by distilling off the reaction solvent under reduced pressure using a rotary evaporator or the like.

The lower limit of the average primary particle size of the functional polishing particles is preferably 5 nm or more, more preferably 7 nm or more, and even more preferably nm or more. Furthermore, the upper limit of the average primary particle size of the functional polishing particles is preferably 500 nm or less, more preferably 250 nm or less, and even more preferably 100 nm or less. When the average primary particle size is in such a range, the occurrence of dishing on the surface of the metal substrate after performing polishing using the polishing composition can be further suppressed. Meanwhile, the average primary particle size of the polishing particles is calculated, for example, based on the specific surface area of the polishing particles measured by the BET method.

The lower limit of the content of the functional polishing particles in the polishing composition is preferably 0.01 g/L or more, more preferably 0.1 g/L or more, and even more preferably 1 g/L or more. Furthermore, the upper limit of the content of the functional polishing particles in the polishing composition is preferably 200 g/L or less, more preferably 150 g/L or less, and even more preferably 100 g/L or less. When the content is in such a range, the cost required for the polishing composition can be suppressed, and the occurrence of dishing on the surface of the metal substrate after performing polishing using the polishing composition can be further suppressed.

The polishing composition of the present invention may include other polishing particles in addition to the functional polishing particles described above. Such other polishing particles may be any of inorganic particles, organic particles, or organic and inorganic composite particles. Specific examples of the inorganic particles include, for example, particles formed from metal oxides that are not surface-modified, such as silica, alumina, ceria, and titania; silicon nitride particles, silicon carbide particles, and boron nitride particles. Specific examples of the organic particles include, for example, polymethyl methacrylate (PMMA) particles. The other polishing particles may be used singly, or may be used in mixture of two or more kinds thereof. Also, regarding the other polishing particles, a commercially available product may be used, or a synthesized product may be used.

[Water]

The polishing composition of the present invention includes water as a dispersing medium or a solvent for dispersing or dissolving the polishing particles. From the viewpoint of suppressing the inhibition of the action of other components, water that does not contain any impurities as far as possible is preferred, and specifically, pure water or ultrapure water obtained by removing impurity ions using an ion exchange resin and then removing foreign substances through a filter, or distilled water is preferred.

[Other Components]

The polishing composition of the present invention may optionally further include other components such as an oxidizing agent, a metal anticorrosive agent, a polishing accelerator, a surfactant, an antiseptic agent, an antifungal agent, a reducing agent, a water-soluble polymer, and an organic solvent for dissolving sparingly soluble organic substances. Among these other components, at least one selected from the group consisting of an oxidizing agent, a metal anticorrosive agent, a polishing accelerator, and a surfactant is preferred. Hereinafter, the oxidizing agent, metal anticorrosive agent, polishing accelerator, and surfactant as the preferred other components will be explained.

[Oxidizing Agent]

The polishing composition related to the present invention may include an oxidizing agent. The oxidizing agent included in the polishing composition has an action of oxidizing the surface of a metal substrate, and increases the speed of polishing the metal substrate by the polishing composition.

Examples of the oxidizing agent that can be used include peroxides. Specific examples of the peroxides include hydrogen peroxide, peracetic acid, a percarbonate, urea peroxide, perchloric acid, and persulfates such as sodium persulfate, potassium persulfate and ammonium persulfate. These oxidizing agents may be used singly or in combination of two or more kinds thereof. Among them, persulfates and hydrogen peroxide are preferred, and particularly preferred is hydrogen peroxide.

The content of the oxidizing agent in the polishing composition is preferably 0.1 g/L or more, more preferably 1 g/L or more, and even more preferably 3 g/L or more. As the content of the oxidizing agent is increased, the speed of polishing the metal substrate by the polishing composition is increased.

Also, the content of the oxidizing agent in the polishing composition is preferably 200 g/L or less, more preferably 100 g/L or less, and even more preferably 50 g/L or less. As the content of the oxidizing agent is decreased, the material cost for the polishing composition can be suppressed, and in addition, the burden of the treatment of the polishing composition after use in polishing, that is, the waste water treatment, can be reduced. Furthermore, the risk of excessive oxidation occurring on the metal substrate surface caused by the oxidizing agent can be decreased.

[Metal Anticorrosive Agent]

The polishing composition related to the present invention may include a metal anticorrosive agent. When a metal anticorrosive agent is added to the polishing composition, dishing of the metal substrate after polishing can be further suppressed.

The metal anticorrosive agent that can be used is not particularly limited; however, the metal anticorrosive agent is preferably a heterocyclic compound. The number of members of the heterocyclic ring in the heterocyclic compound is not particularly limited. Furthermore, the heterocyclic compound may be a monocyclic compound, or may be a polycyclic compound having a fused ring. The metal anticorrosive agent may be used singly or in combination of two or more kinds. Furthermore, regarding the metal anticorrosive agent, a commercially available product may be used, or a synthesized product may be used.

Specific examples of the heterocyclic compound that can be used as a metal anticorrosive agent include, for example, nitrogen-containing heterocyclic compounds such as a pyrrole compound, a pyrazole compound, an imidazole compound, a triazole compound, a tetrazole compound, a pyridine compound, a pyrazine compound, a pyridazine compound, a pyrimidine compound, an indolidine compound, an indole compound, an isoindole compound, an indazole compound, a purine compound, a quinolidine compound, a quinoline compound, an isoquinoline compound, a naphthyridine compound, a phthalazine compound a quinoxaline compound, a quinazoline compound, a cinnoline compound, a pteridine compound, a thiazole compound, an isothiazole compound, an oxazole compound, an isoxazole compound, and a furazane compound.

Even more specific examples include, as examples of the pyrazole compound, 1H-pyrazole, 4-nitro-3-pyrazole carboxylic acid, 3,5-pyrazole carboxylic acid, 3-amino-5-phenylpyrazole, 5-amino-3-phenylpyrazole, 3,4,5-tribromopyrazole, 3-aminopyrazole, 3,5-dimethylpyrazole, 3,5-dimethyl-1-hydroxymethylpyrazole, 3-methylpyrazole, 1-methylpyrazole, 3-amino-5-methylpyrazole, 4-aminopyrazolo[3,4-d]pyrimidine, allopurinol, 4-chloro-1H-pyrazolo[3,4-D]pyrimidine, 3,4-dihydroxy-6-methylpyrazolo(3,4-B)-pyridine, and 6-methyl-1H-pyrazolo[3,4-b]pyridin-3-amine.

Examples of the imidazole compound include, for example, imidazole, 1-methylimidazole, 2-methylimidazole, 4-methylimidazole, 1,2-dimethylpyrazole, 2-ethyl-4-methylimidazole, 2-isopropylimidazole, benizimidazole, 5,6-dimethylbenzimidazole, 2-aminobenzimidazole, 2-chlorobenzimidazole, 2-methylbenzimnidazole, 2-(1-hydroxyethyl)benzimidazole, 2-hydroxybenzimidazole, 2-phenylbenzimidazole, 2,5-dimethylbenzimidazole, 5-methylbenzimidazole, 5-nitrobenzimidazole, and 1H-purine.

Examples of the triazole compound include, for example, 1,2,3-triazole (1H-BTA), 1,2,4-triazole, 1-methyl-1,2,4-triazole, methyl-1H-1,2,4-triazole-3-carboxylate, 1,2,4-triazole-3-carboxylic acid, methyl 1,2,4-triazole-3-carboxylate, 1H-1,2,4-triazole-3-thiol, 3,5-diamino-1H-1,2,4-triazole, 3-amino-1,2,4-triazole-5-thiol, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazol-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-diheptyl-4H-1,2,4-triazole, 5-methyl-1,2,4-triazole-3,4-diamine, 1H-benzotriazole, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5-methyl-1H-benzotriazole, 5,6-dimethyl-1H-benzotriazole, 1-(1′,2′-dicarboxyethyl)benzotriazole, 1-[N,N-bis(hydroxyethyl)aminomethyl]benzotriazole, 1-[(N,N-bis(hydroxyethyi)aminomethyl]-5-methylbenzotriazole, and 1-[N,N-bis(hydroxyethyl)aminomethyl]-4-methylbenzotriazole.

Examples of the tetrazole compound include, for example, 1H-tetrazole, 5-methyltetrazole, 5-aminotetrazole, and 5-phenyltetrazole.

Examples of the indazole compound include, for example, 1H-indazole, 5-amino-1H-indazole, 5-nitro-1H-indazole, 5-hydroxy-1H-indazole, 6-amino-1H-indazole, 6-nitro-1H-indazole, 6-hydroxy-1H-indazole, and 3-carboxy-5-methyl-1H-indazole.

Examples of the indole compound include, for example, 1H-indole, 1-methyl-1H-indole, 2-methyl-1H-indole, 3-methyl-1H-indole, 4-methyl-1H-indole, 5-methyl-1H-indole, 6-methyl-1H-indole, 7-methyl-1H-indole, 4-amino-1H-indole, 5-amino-1H-indole, 6-amino-1H-indole, 7-amino-1H-indole, 4-hydroxy-1H-indole, 5-hydroxy-1H-indole, 6-hydroxy-1H-indole, 7-hydroxy-1H-indole, 4-methoxy-1H-indole, 5-methoxy-1H-indole, 6-methoxy-1H-indole, 7-methoxy-1H-indole, 4-chloro-1H-indole, 5-chloro-1H-indole, 6-chloro-1H-indole, 7-chloro-1H-indole, 4-carboxy-1H-indole, 5-carboxy-1H-indole, 6-carboxy-1H-indole, 7-carboxy-1H-indole, 4-nitro-1H-indole, 5-nitro-1H-indole, 6-nitro-1H-indole, 7-nitro-1H-indole, 4-nitrile-1H-indole, 5-nitrile-1H-indole, 6-nitrile-1H-indole, 7-nitrile-1H-indole, 2,5-dimethyl-1H-indole, 1,2-dimethyl-1H-indole, 1,3-dimethyl-1H-indole, 2,3-dimethyl-1H-indole, 5-amino-2,3-dimethyl-1H-indole, 7-ethyl-1H-indole, 5-(aminomethyl)indole, 2-methyl-5-amino-1H-indole, 3-hydroxymethyl-1H-indole, 6-isopropyl-1H-indole, and 5-chloro-2-methyl-1H-indole.

Among these, preferred heterocyclic compounds are triazole compounds, and particularly, 1H-benzotriazole, 5-methyl-1H-benzotriazole, 5,6-dimethyl-1H-benzotriazole, 1-[N,N-bis(hydroxyethyl)aminomethyl]-5-methylbenzotriazole, 1-[N,N-bis(hydroxyethyl)aminomethyl]-4-methylbenzotriazole, 1,2,3-triazole, and 1,2,4-triazole are preferred. Since these heterocyclic compounds have high chemical or physical adsorptive power to the metal substrate surface, the heterocyclic compounds can form a strong protective film on the metal substrate surface. This is advantageous in increasing the flatness of the surface of the metal substrate after performing polishing using the polishing composition of the present invention.

Among these, a preferred metal anticorrosive agent is a nitrogen-containing 5-membered ring compound, and at least one selected from the group consisting of 1H-pyrazole, 1,2,4-triazole, and 1H-tetrazole is more preferred. When these compounds are used, excessive etching of the metal substrate can be suppressed.

The lower limit of the content of the metal anticorrosive agent in the polishing composition is preferably 0.001 g/L or more, more preferably 0.005 g/L or more, and even more preferably 0.01 g/L or more. Furthermore, the upper limit of the content of the metal anticorrosive agent in the polishing composition is preferably 20 g/L or less, more preferably 15 g/L or less, and even more preferably 10 g/L or less. When the content is in such a range, flatness of the surface of the metal substrate after performing polishing using the polishing composition is enhanced, and the speed of polishing of the metal substrate by the polishing composition is increased.

[Polishing Accelerator]

The polishing composition related to the present invention may include a polishing accelerator. The polishing accelerator has a function of increasing the speed of polishing of the metal substrate by the polishing composition by bonding to the surface of the metal substrate through complex formation, and forming an insoluble brittle film on the surface of the metal substrate. Furthermore, the polishing accelerator has an advantageous effect that the speed of polishing of the metal substrate by the polishing composition is increased as a result of the etching action of the polishing accelerator.

Regarding the polishing accelerator, for example, an inorganic acid, an organic acid, an amino acid, a nitrile compound, and a chelating agent can be used. Specific examples of the inorganic acid include sulfuric acid, nitric acid, boric acid, carbonic acid, hypophosphorous acid, phosphorous acid, and phosphoric acid. Specific examples of the organic acid include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimellic acid, maleic acid, phthalic acid, malic acid, tartaric acid, citric acid, and lactic acid. Organic sulfuric acids such as methanesulfonic acid, ethanesulfonic acid, and isethionic acid can also be used. A salt such as an alkali metal salt of an inorganic acid or an organic acid may also be used instead of an inorganic acid or an organic acid, or in combination with an inorganic acid or an organic acid.

Specific examples of the amino acid include glycine, α-alanine, β-alanine, N-methylglycine, N,N-dimethylglycine, 2-aminobutyric acid, norvaline, valine, leucine, norleucine, isoleucine, phenylalanine, proline, sarcosine, ornithine, lysine, taurine, serine, threonine, homoserine, tyrosine, bicine, tricine, 3,5-diiodotyrosine, β-(3,4-dihydroxyphenyl)alanine, thyroxine, 4-hydroxyproline, cysteine, methionine, ethionine, lanthionine, cystathionine, cystine, cysteic acid, aspartic acid, glutamic acid, S-(carboxymethyl)cysteine, 4-aminobutyric acid, asparagine, glutamine, azaserine, arginine, canavanine, citrulline, δ-hydroxylysine, creatine, histidine, 1-methylhistidine, 3-methylhistidine, and tryptophan. Among them, glycine, alanine, malic acid, tartaric acid, citric acid, glycolic acid, isethionic acid, and salts thereof are preferred.

Specific examples of the nitrile compound include, for example, acetonitrile, aminoacetonitrile, propionitrile, butyronitrile, isobutyronitrile, benzonitrile, glutarodinitrile, and methoxyacetonitrile.

Specific examples of the chelating agent include nitrilotriacetic acid, diethylenetriamine pentaacetic acid, ethylenediamine tetraacetic acid, N,N,N-trimethylenephosphonic acid, ethylenediamine-N,N,N′,N′-tetramethylenesulfonic acid, trans-cyclohexanediamine tetraacetic acid, 1,2-diaminopropane tetraacetic acid, glycol ether diamine tetraacetic acid, ethylenediamine ortho-hydroxyphenylacetic acid, ethylenediamine disuccinic acid (SS form), N-(2-carboxylatoethyl)-L-aspartic acid, β-alanine diacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid.

The lower limit of the content of the polishing accelerator in the polishing composition is preferably 0.01 g/L or more, more preferably 0.1 g/L or more, and even more preferably 1 g/L or more. As the content of the polishing accelerator increases, the speed of polishing of the metal substrate by the polishing composition is increased. On the other hand, the upper limit of the content of the polishing accelerator in the polishing composition is preferably 50 g/L or less, more preferably 30 g/L or less, and even more preferably 15 g/L or less. As the content of the polishing accelerator is decreased, the material cost of the polishing composition can be suppressed.

[Surfactant]

The polishing composition related to the present invention may include a surfactant. When a surfactant is added to the polishing composition, dishing of the metal substrate after polishing can be further suppressed.

The surfactant used may be any one of an anionic surfactant, a cationic surfactant, an amphoteric surfactant, and a nonionic surfactant, and among them, an anionic surfactant and a nonionic surfactant are preferred. Plural kinds of surfactants may be used in combination, and it is particularly preferable to use an anionic surfactant and a nonionic surfactant in combination.

Specific examples of the anionic surfactant include, for example, a polyoxyethylene alkyl ether acetic acid, a polyoxyethylene alkyl ether sulfuric acid, an alkyl ether sulfuric acid, a polyoxyethylene alkyl sulfuric acid ester, an alkyl sulfuric acid ester, a polyoxyethylene alkyl sulfuric acid, an alkyl sulfuric acid, an alkyl benzenesulfonic acid, an alkyl phosphoric acid ester, a polyoxyethylene alkyl phosphoric acid ester, a polyoxyethylene sulfosuccinic acid, an alkyl sulfosuccinic acid, an alkyl naphthalenesulfonic acid, an alkyl diphenyl ether disulfonic acid, and salts thereof. Among them, a polyoxyethylene alkyl ether acetic acid, a polyoxyethylene alkyl ether sulfate, an alkyl ether sulfate, and an alkyl benzenesulfonate are preferred. These preferred anionic surfactants have high chemical or physical adsorptive power to the metal substrate surface, and therefore, a stronger protective film is formed on the metal substrate surface. This is advantageous in enhancing the flatness of the surface of the metal substrate after performing polishing using the polishing composition.

Specific examples of the cationic surfactant include, for example, an alkyltrimethylammonium salt, an alkyldimethylammonium salt, an alkylbenzyldimethylammonium salt, and an alkylamine salt.

Specific examples of the amphoteric surfactant include, for example, an alkylbetaine and an alkylamine oxide. Specific examples of the nonionic surfactant include, for example, polyoxyalkylene alkyl ethers such as a polyoxyethylene alkyl ether; a sorbitan fatty acid ester, a glycerin fatty acid ester, a polyoxyethylene fatty acid ester, a polyoxyethylene alkylamine, and an alkylalkanolamide. Among them, a polyoxyalkylene alkyl ether is preferred. Since a polyoxyalkylene alkyl ether has high chemical or physical adsorptive power to the metal substrate surface, a stronger protective film is formed on the metal substrate surface. This is advantageous in enhancing the flatness of the surface of the metal substrate after performing polishing using the polishing composition.

The content of the surfactant in the polishing composition is preferably 0.001 g/L or more, more preferably 0.005 g/L or more, and even more preferably 0.01 g/L or more. As the content of the surfactant is increased, it is advantageous that the flatness of the surface of the metal substrate after performing polishing using the polishing composition is enhanced. Furthermore, the content of the surfactant in the polishing composition is preferably 20 g/L or less, more preferably 15 g/L or less, and even more preferably 10 g/L or less. As the content of the surfactant is decreased, it is advantageous that the speed of polishing by the polishing composition is increased.

[pH of Polishing Composition]

The lower limit of the pH of the polishing composition of the present invention is preferably 1.5 or higher. As the pH of the polishing composition increases, the risk of excessive etching occurring on the metal substrate surface due to the polishing composition can be reduced.

Furthermore, the upper limit of the pH of the polishing composition is preferably 12 or lower. As the pH of the polishing composition decreases, depressions occurring in the flanks of the wiring formed by polishing using the polishing composition can be further suppressed, and dissolution of the polishing particles can be prevented.

In order to adjust the pH of the polishing composition to a desired value, a pH adjusting agent may be used. The pH adjusting agent used may be any one of an acid or an alkali, and may also be any one of an inorganic compound or an organic compound. Meanwhile, the pH adjusting agent can be used singly or in combination of two or more kinds thereof. Furthermore, in the case of using additives having a pH adjusting function (for example, various acids) as the various additives described above, the relevant additives may also be used as at least a portion of the pH adjusting agent.

[Method for Producing Polishing Composition]

The method for producing the polishing composition of the present invention is not particularly limited, and for example, the polishing composition can be obtained by mixing with stirring functional polishing particles and optionally other components in water.

The temperature at the time of mixing various components is not particularly limited; however, the temperature is preferably 10° C. to 40° C., and it is also acceptable to heat the system in order to increase the dissolution speed. Furthermore, the mixing time is also not particularly limited.

[Polishing Method and Method for Producing Substrate]

As explained above, the polishing composition of the present invention is suitably used for the polishing of a metal substrate described above. Therefore, the present invention provides a polishing method of performing polishing using the polishing composition of the present invention. Furthermore, the present invention provides a method for producing a metal substrate, the method including a step of polishing a metal substrate by the polishing method described above.

Regarding a polishing apparatus, a general polishing apparatus which is equipped with a holder for retaining a metal substrate or the like, a motor capable of varying the speed of rotation, and the like, and a polishing surface table on which a polishing pad (polishing cloth) can be attached, can be used.

Regarding the polishing pad, a general non-woven fabric, a polyurethane, a porous fluororesin, and the like can be used without any particular limitations. It is preferable that the polishing pad be subjected to groove processing for collecting the polishing liquid.

There are no particular limitations on the polishing conditions, and for example, the speed of rotation of the polishing surface table is preferably 10 to 500 rpm, while the pressure applied to the metal substrate (polishing pressure) is preferably 0.5 to 10 psi. There are no particular limitations on the method of supplying the polishing composition to a polishing pad, and for example, a method of continuously supplying the polishing composition with a pump or the like is employed. This amount of supply is not limited, but it is preferable that the surface of the polishing pad be covered with the polishing composition of the present invention all the time.

After completion of polishing, the substrate is washed under flowing water and is dried by dropping the water droplets adhering on the substrate using a spin dryer or the like. Thus, a metal substrate is obtained.

The polishing composition of the present invention may be a one-liquid type, or may be a multi-liquid type including a two-liquid type. Furthermore, the polishing composition of the present invention may be prepared by diluting a stock solution of the polishing composition, for example, to 10 times or more using a diluent such as water.

### EXAMPLES

### Synthesis of Silane Coupling Agent

### Synthesis Example

In a 10 L reactor equipped with a thermometer and a stirring blade, 2432 g (10 mol) of 3-bromopropyltrimethoxysilane and 5 L of a mixed solvent of toluene:xylene=1:1 (volume ratio) were introduced, and the mixture was stirred for 1 hour. Thus, a solution was obtained. 1191 g (10 mol) of 1,2,3-benzotriazole was added to this solution, and the mixture was stirred for 1 hour. Subsequently, 10 μmol of sulfuric acid as an acid catalyst was added thereto, and then the mixture was stirred for 10 minutes. Subsequently, the flask was left to stand for 4 hours in an air bath at 50° C. to cause the reaction to proceed. After completion of the reaction, toluene and sulfuric acid were removed using a rotary evaporator, and thus N-[3-(triethoxysilylpropyl)]benzotriazole, which was an intended product, was obtained.

[Synthesis of Functional Polishing Particles]

### Example 1

1000 g (concentration 19.5% by weight) of an aqueous solution of colloidal silica was provided. Separately, 7.5 g of N-[3-(triethoxysilylpropyl)]benzotriazole, which was a silane coupling agent obtained in the Synthesis Example described above, was weighed and dissolved in 50 g of methanol. This amount of the silane coupling agent is an amount corresponding to 50% by mole of the number of moles calculated by determining the apparent number of moles of the colloidal silica from the specific surface area of the colloidal silica measured by the BET method, according to the above-described Mathematical Formula 1 by taking the occupied area of one molecule of the silane coupling agent as (5×10⁻¹⁰)² (m²)=25×10⁻²⁰ (m²).

While the colloidal silica solution was stirred in an air atmosphere at 40° C. at a speed of rotation of the stirring blade of 600 rpm, a methanol solution of the silane coupling agent was added dropwise thereto at a rate of 1 ml/min. After the dropwise addition, the pH was adjusted using a pH adjusting agent (KOH) such that the pH of the solution reached 8.0 to 9.0.

After the pH adjustment, the solution was left to stand for 8 hours in an air bath at 40° C., and then the solution was left to stand for 12 hours in an air bath at 60° C. Subsequently, methanol was removed by a rotary evaporator, and thus functional polishing particles 1 were obtained.

The functional polishing particles 1 thus obtained were subjected to an XPS (X-ray photoelectron spectroscopy) analysis, and thus it was confirmed that chemical bonding of Si—O—Si was formed. Furthermore, the functional polishing particles 1 thus obtained were subjected to an FT-IR (Fourier transformation infrared spectroscopy) analysis, and thus it was confirmed that the functional polishing particles 1 had a benzotriazolyl group as a functional group. Therefore, it was confirmed by these two analysis methods that intended functional polishing particles which contained a surface-modifying group having a benzotriazolyl group at one end and having a propylenedimethoxysiloxy group as a linking group, and silica to which the surface-modifying group was immobilized, were formed.

### Example 2

Functional polishing particles 2 were obtained in the same manner as in Example 1, except that 8.2 g (50% by mole relative to the apparent number of moles of the colloidal silica) of IM-2000 (manufactured by JX Nippon Mining & Metals Corp.) was used instead of N-[3-(triethoxysilylpropyl)]benzotriazole.

The functional polishing particles 2 thus obtained were subjected to an XPS (X-ray photoelectron spectroscopy) analysis, and it was confirmed that chemical bonding of Si—O—Si was formed. Furthermore, the functional polishing particles 2 thus obtained were subjected to a FT-IR (Fourier transformation infrared spectroscopy) analysis, and it was confirmed that the functional polishing particles 2 had a mercapto group as a functional group. Therefore, it was confirmed by these two analysis methods that intended functional polishing particles which contained a surface-modifying group having a dihydroimidazolyl group at one end and having a propylenedimethoxysiloxy group as a linking group, and silica to which the surface-modifying group was immobilized, were formed.

### Example 3

Functional polishing particles 3 were obtained in the same manner as in Example 1, except that 3.9 g (50% by mole relative to the apparent number of moles of the colloidal silica) of KBM-803 (manufactured by Shin-Etsu Chemical Co., Ltd., 3-mercaptopropyltrimethoxysilane) was used instead of N-[3-(triethoxysilylpropyl)]benzotriazole.

The functional polishing particles 3 thus obtained were subjected to an XPS (X-ray photoelectron spectroscopy) analysis, and it was confirmed that chemical bonding of Si—O—Si was formed. Furthermore, the functional polishing particles 3 thus obtained were subjected to a FT-IR (Fourier transformation infrared spectroscopy) analysis, and it was confirmed that the functional polishing particles 3 had a phenyl group as a functional group. Therefore, it was confirmed by these two analysis methods that intended functional polishing particles which contained a surface-modifying group having a mercapto group at one end and having a propylenedimethoxysiloxy group as a linking group, and silica to which the surface-modifying group was immobilized, were formed.

### Example 4

Functional polishing particles 4 were obtained in the same manner as in Example 1, except that 4.1 g (50% by mole relative to the apparent number of moles of the colloidal silica) of trimethoxyphenylsilane (manufactured by Tokyo Chemical Industry Co., Ltd.) was used instead of N-[3-(triethoxysilylpropyl)]benzotriazole.

The functional polishing particles 4 thus obtained were subjected to an XPS (X-ray photoelectron spectroscopy) analysis, and it was confirmed that chemical bonding of Si—O—Si was formed. Furthermore, the functional polishing particles 4 thus obtained were subjected to a FT-IR (Fourier transformation infrared spectroscopy) analysis, and it was confirmed that the functional polishing particles 4 had a cyano group as a functional group. Therefore, it was confirmed by these two analysis methods that intended functional polishing particles which contained a surface-modifying group having a phenyl group at one end and having a propylenedimethoxysiloxy group as a linking group, and silica to which the surface-modifying group was immobilized, were formed.

### Example 5

Functional polishing particles 5 were obtained in the same manner as in Example 1, except that 3.2 g (50% by mole relative to the apparent number of moles of the colloidal silica) of 2-cyanoethyltriethoxysilane (manufactured by Tokyo Chemical Industry Co., Ltd.) was used instead of N-[3-(triethoxysilylpropyl)]benzotriazole.

The functional polishing particles 5 thus obtained were subjected to an XPS (X-ray photoelectron spectroscopy) analysis, and it was confirmed that chemical bonding of Si—O—Si was formed. Furthermore, the functional polishing particles 5 thus obtained were subjected to a FT-IR (Fourier transformation infrared spectroscopy) analysis, and it was confirmed that the functional polishing particles 5 had a cyano group as a functional group. Therefore, it was confirmed by these two analysis methods that intended functional polishing particles which contained a surface-modifying group having a cyano group at one end and having a propylenedimethoxysiloxy group as a linking group, and silica to which the surface-modifying group was immobilized, were formed.

[Preparation of Polishing Composition]

Polishing compositions were prepared using the functional polishing particles 1 to 5 thus obtained. Specifically, 6 g/L of functional polishing particles, 10 g/L of glycine as a polishing accelerator, 35 g/L of hydrogen peroxide as an oxidizing agent, and 0.2 g/L of 1H-benzotriazole as a metal anticorrosive agent were mixed with stirring in water so as to obtain the respective indicated concentrations (mixing temperature: about 25° C., mixing time: about 10 minutes), and thus polishing compositions 1 to 5 were prepared. The pH of the polishing compositions was adjusted to pH 7.0 by adding potassium hydroxide.

The speed of polishing and etching rate with respect to Cu were evaluated using the polishing compositions 1 to thus obtained. The polishing conditions were as indicated in the following Table 1.

TABLE 1

| | |
|---|---|
| Polishing machine: | Single surface CMP polishing |
| | machine for 200 mm |
| Pad: | Polishing pad made of polyurethane |
| Pressure: | 2 psi |
| Speed of rotation of surface table: | 63 rpm |
| Speed of rotation of carrier: | 57 rpm |
| Slurry flow rate: | 100 ml/min |
| Polishing time: | 1 minute |

The speed of polishing was evaluated by determining the thicknesses of a 200-mm Cu wafer before and after polishing from the sheet resistance according to a direct current four-probe method, and dividing the difference by the polishing time.

The etching rate was evaluated by immersing a Cu wafer for 1 minute at 25° C., and then determining the weight change.

Meanwhile, as a Comparative Example, a polishing composition was prepared in the same manner as described above, using a colloidal silica that was not surface-modified (average primary particle size: 35 nm, average secondary particle size: 68 nm) instead of the functional polishing particles 1 to 5, and the polishing composition was evaluated similarly.

The evaluation results are presented in the following Table 2.

TABLE 2

| | | | | | | Compar- |
|---|---|---|---|---|---|---|
| | | | | | | ative |
| | Exam- | Exam- | Exam- | Exam- | Exam- | Exam- |
| | ple 1 | ple 2 | ple 3 | ple 4 | ple 5 | ple |
| Etching rate | 2 | 2 | 2 | 4 | 3 | 5 |
| (Å/min) | | | | | | |
| Speed of | 400 | 550 | 2200 | 1600 | 1800 | 1200 |
| polishing | | | | | | |
| (Å/min) | | | | | | |

As is obvious from the above Table 2, the polishing compositions of Examples (polishing compositions of the present invention) containing the functional polishing particles have low etching rates, and dishing of the metal surface can be suppressed.

Furthermore, an evaluation was carried out on the scratches generated on a 200-mm Cu wafer after performing polishing using the polishing compositions of Example 1 and the Comparative Example. The scratches were evaluated under the conditions in which scratches having a size of 0.16 μm or more can be detected, with a light interference type wafer surface inspection apparatus.

As a result, the number of scratches was 65 in the case of using the polishing composition of Comparative Example, and the number of scratches was 20 in the case of using the polishing composition of Example 1. Therefore, it was found that scratches were reduced when the polishing composition of Example 1 was used.

The present application is based on Japanese Patent Application No. 2012-288415 filed on Dec. 28, 2012, the entire disclosure of which is incorporated herein by reference.

1. A polishing composition comprising functional polishing particles and water, the functional polishing particles containing a surface-modifying group having, at one end, a functional group capable suppressing dissolution of a metal substrate by adsorbing to the metal substrate, and metal oxide particles to which the surface-modifying group is immobilized.

2. The polishing composition according to claim 1, wherein the functional group is at least one selected from the group consisting of a mercapto group, a cyano group, a phenyl group, a dihydroimidazolyl group, a benzotriazolyl group, and a tetrazolyl group.

3. The polishing composition according to claim 1, further comprising at least one selected from the group consisting of an oxidizing agent, a metal anticorrosive agent, a polishing accelerator, and a surfactant.

4. A polishing method comprising polishing a metal substrate using the polishing composition according to claim 1.

5. A method for producing a metal substrate, the method comprising polishing a metal substrate by the polishing method according to claim 4.
